(19) United States
(12) Patent Application Publication
(10) Pub. No.: US 2020/0383278 A1
(43) Pub. Date: Dec. 10, 2020

(54) Weed Barrier Assembly

(71) Applicant: Ronald Unger, Martinsburg, WV (US)

(72) Inventor: Ronald Unger, Martinsburg, WV (US)

(21) Appl. No.: 16/433,836

(22) Filed: Jun. 6, 2019

(51) Int. Cl. A01G 13/02

(52) U.S. Cl. CPC A01G 13/0268

(57) ABSTRACT

A weed barrier assembly for inhibiting unwanted plants from growing includes a first sheet that is laid on the ground in a selected area to inhibit unwanted plants from growing in the selected area. A second sheet is bonded to the first sheet. The second sheet is comprised of a fluid impermeable material to inhibit unwanted plants from growing through the second sheet. A third sheet is bonded to the second sheet such that the third sheet is exposed when the first sheet is placed on the ground.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to barrier devices and more particularly pertains to a new barrier device for inhibiting unwanted plants from growing.

### BRIEF SUMMARY OF THE INVENTION

An embodiment of the disclosure meets the needs presented above by generally comprising a first sheet that is laid on the ground in a selected area to inhibit unwanted plants from growing in the selected area. A second sheet is bonded to the first sheet. The second sheet is comprised of a fluid impermeable material to inhibit unwanted plants from growing through the second sheet. A third sheet is bonded to the second sheet such that the third sheet is exposed when the first sheet is placed on the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a weed barrier assembly according to an embodiment of the disclosure.

FIG. 2 is an exploded perspective view of an embodiment of the disclosure.

FIG. 3 is a cross sectional view taken along line 3-3 of FIG. 1 of an embodiment of the disclosure.

### DETAILED DESCRIPTION OF THE INVENTION

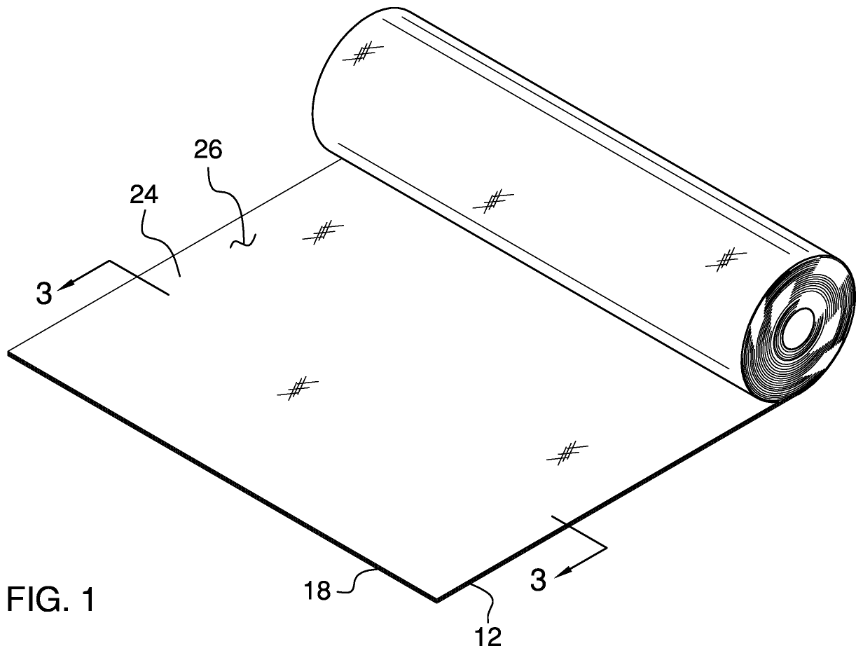

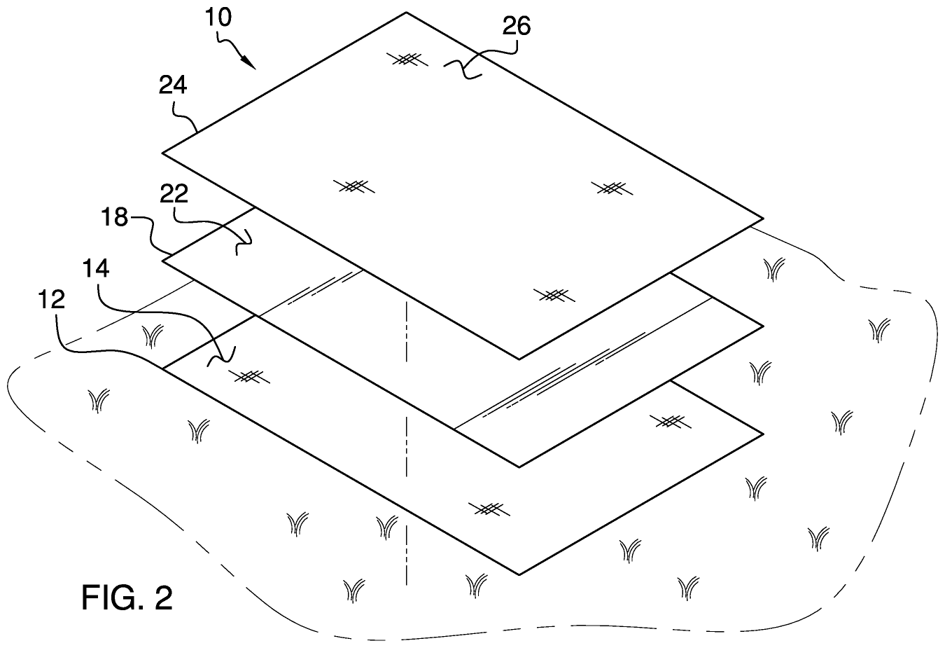

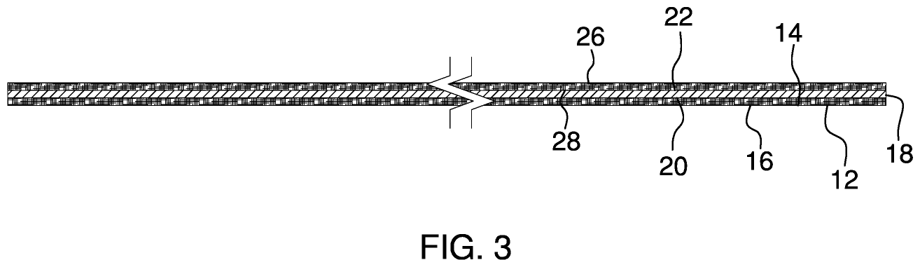

With reference now to the drawings, and in particular to FIGS. 1 through 3 thereof, a new barrier device embodying the principles and concepts of an embodiment of the disclosure and generally designated by the reference numeral 10 will be described.

As best illustrated in FIGS. 1 through 3, the weed barrier assembly 10 generally comprises a first sheet 12 that is laid on the ground in a selected area to inhibit unwanted plants from growing in the selected area. The selected area may be a flower bed, a newly seeded lawn or any other area in which certain plants are desired and others are not. The first sheet 12 is comprised of a fluid permeable material, such as a fabric mesh or the like, to pass fluid therethrough. Additionally, the first sheet 12 may have a length of at least 3.0 meters and a width of at least 1.0 meters and the first sheet 12 may be rolled up into a roll. The first sheet 12 has a top surface 14 and a bottom surface 16.

A second sheet 18 is provided and the second sheet 18 is bonded to the first sheet 12. The second sheet 18 is comprised of a fluid impermeable material to inhibit unwanted plants from growing through the second sheet 18. The fluid impermeable material may be aluminum foil, plastic or any other flexible, fluid impermeable material. Additionally, the fluid impermeable material may be any material that can be cut with scissors, a knife or any other household cutting tool. The second sheet 18 has a lower surface 20 and an upper surface 22, and the lower surface 20 is bonded to the top surface 14 of the first sheet 12. Moreover, the second sheet 18 completely covers the top surface 14 of the first sheet 12.

A third sheet 24 is provided and the third sheet 24 is bonded to the second sheet 18 such that the third sheet 24 is exposed when the first sheet 12 is placed on the ground. The third sheet 24 is comprised of a fluid permeable material, such as a fabric mesh or the like, to pass fluid therethrough. The third sheet 24 has a topmost surface 26 and a bottommost surface 28, and the bottommost surface 28 is bonded to the upper surface 22 of the second sheet 18. Additionally, the third sheet 24 completely covers the second sheet 18.

In use, each of the first 12, second 18 and third 24 sheets are rolled out onto a selected area outdoors such that the first sheet 12 lies on the ground. Each of the first 12, second 18 and third 24 sheets are trimmed to a selected size or shape to cover the selected area in a preferred manner. In this way the first 12, second 18 and third 24 sheets can be positioned around flowers or other plants that a user wants to grow in the selected area. The second sheet 18 inhibits weeds and any other unwanted plants from growing in the selected area. In this way the selected area is keep free of weeds or any other unwanted plants while facilitating the flowers or other plants that the user wishes to grow in the selected area.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weed barrier assembly being configured to be positioned on the ground in an area to prevent unwanted plants from growing in the area, said assembly comprising:
a first sheet being laid on the ground in a selected area wherein said first sheet is configured to inhibit unwanted plants from growing in the selected area;
a second sheet being bonded to said first sheet, said second sheet being comprised of a fluid impermeable material wherein said second sheet is configured to inhibit unwanted plants from growing through said second sheet; and
a third sheet being bonded to said second sheet such that said third sheet is exposed when said first sheet is placed on the ground.

2. The assembly according to claim 1, wherein:
said first sheet has a bottom surface and a top surface, said bottom surface being configured to abut the ground in the selected area;
said second sheet has a lower surface and an upper surface, said lower surface being bonded to said top surface of said first sheet, said second sheet completely covering said top surface of said first sheet; and
said third sheet has a topmost surface and a bottommost surface, said bottommost surface being bonded to said upper surface of said second sheet, said third sheet completely covering said second sheet.

3. The assembly according to claim 2, wherein said first sheet is comprised of a fluid permeable material wherein said first sheet is configured to pass fluid therethrough.

4. The assembly according to claim 2, wherein said third sheet is comprised of a fluid permeable material wherein said third sheet is configured to pass fluid therethrough.

5. A weed barrier assembly being configured to be positioned on the ground in an area to prevent unwanted plants from growing in the area, said assembly comprising:
a first sheet being laid on the ground in a selected area wherein said first sheet is configured to inhibit unwanted plants from growing in the selected area, said first sheet being comprised of a fluid permeable material wherein said first sheet is configured to pass fluid therethrough, said first sheet having a bottom surface and a top surface, said bottom surface being configured to abut the ground in the selected area;
a second sheet being bonded to said first sheet, said second sheet being comprised of a fluid impermeable material wherein said second sheet is configured to inhibit unwanted plants from growing through said second sheet, said second sheet having a lower surface and an upper surface, said lower surface being bonded to said top surface of said first sheet, said second sheet completely covering said top surface of said first sheet; and
a third sheet being bonded to said second sheet such that said third sheet is exposed when said first sheet is placed on the ground, said third sheet being comprised of a fluid permeable material, said third sheet having a topmost surface and a bottommost surface, said bottommost surface being bonded to said upper surface of said second sheet, said third sheet completely covering said second sheet.

6. A method of inhibiting weed growth in a selected area, the steps of the method comprising:
providing a first sheet being comprised of a fluid permeable material wherein said first sheet is configured to pass fluid therthrough;
providing a second sheet being bonded to said first sheet, said second sheet being comprised of a fluid impermeable material wherein said second sheet is configured to inhibit plants from growing through said second sheet;
providing a third sheet being bonded to said second sheet, said third sheet being comprised of a fluid permeable material; and
positioning said first sheet on the ground in a selected area wherein each of said first, second and third sheets is configured to inhibit unwanted plants from growing in the selected area.
